(19) United States
(12) Patent Application Publication
(10) Pub. No.: US 2002/0176363 A1
(43) Pub. Date: Nov. 28, 2002

(54) Method for load balancing in routers of a network using overflow paths

(76) Inventors: Sanja Durinovic-Johri, Aberdeen, NJ (US); Pravin Kumar Johri, Aberdeen, NJ (US)

Correspondence Address: Samuel H. Dworetsky, AT&T CORP., P.O. Box 4110, Middletown, NJ, 07748-4110, US

(21) Appl. No.: 09/851,284

(22) Filed: May 8, 2001

(51) Int. Cl. H04L 12/26

(52) U.S. Cl. 370/237; 370/229; 709/239

(57) ABSTRACT

A method for managing packet flow in network routers is provided which communicates the congestion status among the ports inside routers in the network, and substantially eliminates packet dropping due to congestion by providing overflow paths for destination IP addresses. Each router in a network stores at least two possible output paths for selected destination IP addresses, so that the router may direct the output of packets appropriately when congestion is detected on one of the paths. A forwarding table stores the possible output paths for each destination IP address.

### TECHNICAL FIELD

The present invention relates to managing data packet flow in routers of networks. More particularly, the present invention is directed to a method and apparatus for communicating congestion status information between ports inside routers in the network, and transmitting information from a router on an alternate path when congestion is detected on a primary path of the router.

### BACKGROUND OF THE INVENTION

Networks are widely used in today's digital world to communicate information between end systems such as users, servers, and the like. Information is usually transmitted in the form of IP (Internet Protocol) packets of digital data. Each IP packet has a header with the source IP address and port number, the destination IP address and port number, and other fields. The network is responsible for delivering the IP packets to their respective destinations. In order to perform this task, networks usually include routers for routing and transmitting the data packets.

A router may be connected to another router by a transmission link. The transmission link connects a port on the first router to a port on the second router. All of the pairs of routers may not be connected and, conversely, there may be multiple links between any two given routers. A link weight is assigned to each link by the administrator of the network. Each router in the network runs one or more routing protocols such as the Open Shortest Path First (OSPF) protocol or the Multiprotocol Label Switching (MPLS) protocol, or some other suitable routing protocol. Different routing protocols may be used in different portions of the network, and any one segment may run more than one protocol.

The routing protocols enable the routers to determine the layout of the network, where the destination for each IP packet is located, and a route or path for transmitting the information to the destination. The transmission of data from the source to the destination usually requires a number of routers and the path taken by the IP packet will include these routers and the links connecting the routers. Each router in the network is responsible for independently selecting the path for transmitting an IP packet to its destination. In each router, this selection is based upon information stored in one or more forwarding tables. There is typically one forwarding table per routing protocol. In each router, only one path is selected, from among possible paths, to transmit information to a particular destination. The selection is determined by the routing protocol. The path chosen typically has the shortest length, measured as the sum of the weights assigned to the links in the path. The router stores the information for the next hop or output link in the path in its forwarding table, which identifies the outgoing link from the router. There is one forwarding table per router regardless of the number of routing protocols. If there are multiple paths with equal length, as is the case when there are multiple links with equal weights between a pair of routers and these links are in the path, then multiple forwarding table entries may be created, one for each path. However, the set of destination IP addresses that match these entries is partitioned among the entries, so that each address is assigned to a unique entry. This is known as load balancing among equal length paths.

Once a path is selected and the port is identified, the data is supplied to a transmit buffer associated with the port. The data is stored in the transmit buffer until the router is ready to transmit the data from the associated port. Occasionally, a link from a router becomes congested. Congestion causes the transmit buffer for this link in the router to back up and eventually become full. When the transmit buffer for a particular link becomes full, the router begins to drop the received IP packets until the congestion clears.

Approaches have been developed to address the problem of dropping packets when congestion occurs in the network. In one approach, the level of each of the transmit buffers may be monitored to determine when it is approaching capacity. When it is determined that a transmit buffer is approaching capacity, the router may begin to drop some of the IP packets. This type of approach is known as Random Early Discard (RED). That is, the router may select which packets to drop. Often, the selection may be made based upon the priority of the packet as indicated in the header of the packet, where the lowest priority packets may be dropped when congestion occurs. This enables the buffer to maintain space for higher priority packets. Other variations of the basic RED scheme, such as Weighted RED (WRED) and BLUE, are available for attempting to control packet dropping when congestion occurs in the network.

The problem with the foregoing approaches is that a single path from a router is used for a particular destination IP address, regardless of whether there is congestion. This is true even when the router is employing load balancing among equal length paths. The only option the router has when congestion occurs on one of its links is to drop data packets assigned to paths that use that link. Another problem with the foregoing approaches is that the congestion controls are applied only in the outgoing link after the packet has been routed to it from the incoming link. At this point, routing the packet to another possibly uncongested outgoing link is no longer an option.

Therefore, there is a need for a method that communicates the congestion status from an outgoing link to the incoming links inside the router, selects overflow paths that avoid the congested link, routes incoming packets destined for the congested link onto outgoing links corresponding to the overflow paths, and prevents packet dropping due to congestion.

### SUMMARY OF THE INVENTION

The foregoing deficiencies of the prior art are overcome by the present invention, which provides a method for communicating the congestion status of an outgoing link(s) to the incoming link(s) inside a router, and substantially eliminates packet dropping due to congestion by providing overflow paths for selected destination IP addresses. Related apparatus is described and claimed in U.S. patent application Ser. No. (Attorney Docket No. IDS 1999-0647A) filed concurrently herewith and incorporated herein by reference as to its entire contents.

According to an aspect of the present invention, some of the destination IP addresses out of all possible destination IP addresses are selected and marked as eligible for overflow routing. Each router in a network stores at least two possible output paths for the selected destination IP addresses, so that the router may direct the output of packets appropriately when congestion is detected on one of the paths.

According to another aspect of the present invention, a forwarding table stores the information for the next hops of possible output paths for the selected destination IP addresses.

According to yet another aspect of the present invention, the congestion status of an outgoing link in each router is communicated to the incoming links in the router.

According to another aspect of the present invention, overflow paths are selected on the incoming links for the selected IP destination addresses when congestion is detected, and packets originally destined for the congested outgoing link are routed to the overflow path.

These and other objects and features of the present invention will become apparent upon consideration of the following detailed description of preferred embodiments thereof, presented in connection with the following drawings in which like reference numerals identify like elements throughout.

### BRIEF DESCRIPTION OF THE DRAWINGS

In the drawings,

FIG. 1 illustrates an example of a network;

FIG. 2 illustrates an arrangement of one of the routers shown in FIG. 1;

FIG. 3 shows an example of part of a forwarding table according to the present invention;

FIG. 4 is a flow diagram showing processing steps for generating a forwarding table according to an aspect of the present invention; and

FIG. 5 is a flow diagram showing the processing steps for overflow processing according to an aspect of the present invention.

### DETAILED DESCRIPTION OF THE INVENTION

The routing of data within an autonomous system, such as a network, is usually governed by an interior gateway protocol such as the Router Information Protocol (RIP), OSPF protocol or Interior Boarder Gateway Protocol (IBGP), and the like. Data is transmitted within the network via routers. The routing protocol is usually responsible for generating a forwarding or routing table that at least includes a source port ID, a source IP address, a destination IP address, and a destination port ID. In each router of a conventional system, a single output path is selected and stored for each destination IP address in the network. This path is usually selected by the routing protocol and its first hop is stored in the forwarding table for each corresponding destination IP address. Sometimes the forwarding table entry is for a set of IP addresses that is typically defined by an IP address and a prefix or mask. The use of prefixes or masks is well known in the art, and the present invention applies equally to this case or when both cases are present. The first hop identifies the outgoing link on the router.

When the router receives a packet, the destination IP address is read and the outgoing link is determined based upon the entry matching the destination IP address in the forwarding table. The router may use other fields, such as the source IP address, in addition to the destination IP address to map the IP packet to an entry in the forwarding table. The data packet may be supplied to a transmit buffer corresponding to the port of the outgoing link. In conventional systems, since only a single output link is selected for each destination IP address, when the link becomes congested and the transmit buffer for the output link becomes full, the router begins to drop the IP packets. The present invention was designed to address the problem of dropping packets of data upon network congestion. It will be appreciated by those of ordinary skill in the art that the present invention may be employed with any interior gateway protocol.

According to an aspect of the present invention, at least two possible paths are selected by the routing protocol for each destination IP address and their first hops or outgoing links are stored in the forwarding table of the router. These two paths can be of different length. One path is usually designated as the primary path and alternate paths are generally designated as secondary paths. The secondary path(s) are usually longer than the primary path. The primary path, for a particular destination IP address may be selected for transmitting packet data unless congestion is detected. The congestion information is from the router itself, e.g., from one of the output ports of the router. Any method of detecting congestion may be used to implement the present invention. Upon detection of congestion in the primary path, a router may select an alternate or overflow path stored in the forwarding table of the router for the particular destination IP address in order to transmit the data. Therefore, according to the present invention, the dropping of IP packets due to congestion may be avoided. Once the congestion has abated, the router may once again transmit data via the primary path for the particular destination IP address. This processing may occur at each of the routers in the network. Accordingly, each router may respond to congestion information as appropriate to avoid dropping IP packets.

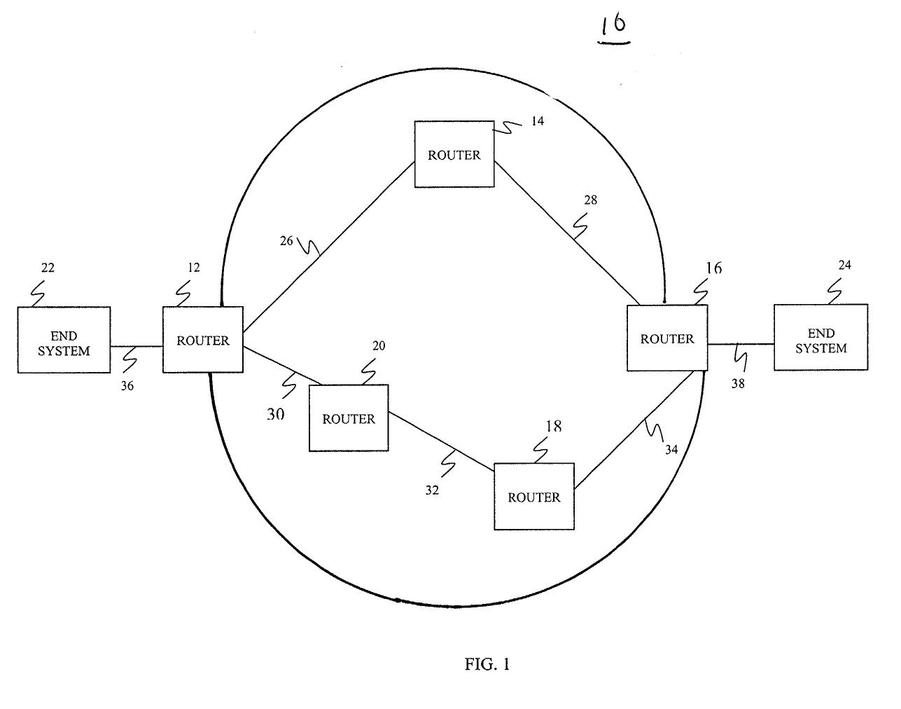

An example of a network arrangement is shown in FIG. 1. The network 10 includes routers 12, 14, 16, 18 and 20. The routers are connected via network links 26, 28, 30, 32, and 34. Routers usually include port cards each having a plurality of ports (not shown). Links usually begin and end in ports, and therefore, a port ID in a router may be mapped to a link ID. Two end systems 22 and 24 are shown in FIG. 1. However, the network 10 may include any number of end systems. The end systems 22 and 24 are connected to the network 10 via access links 36 and 38, respectively.

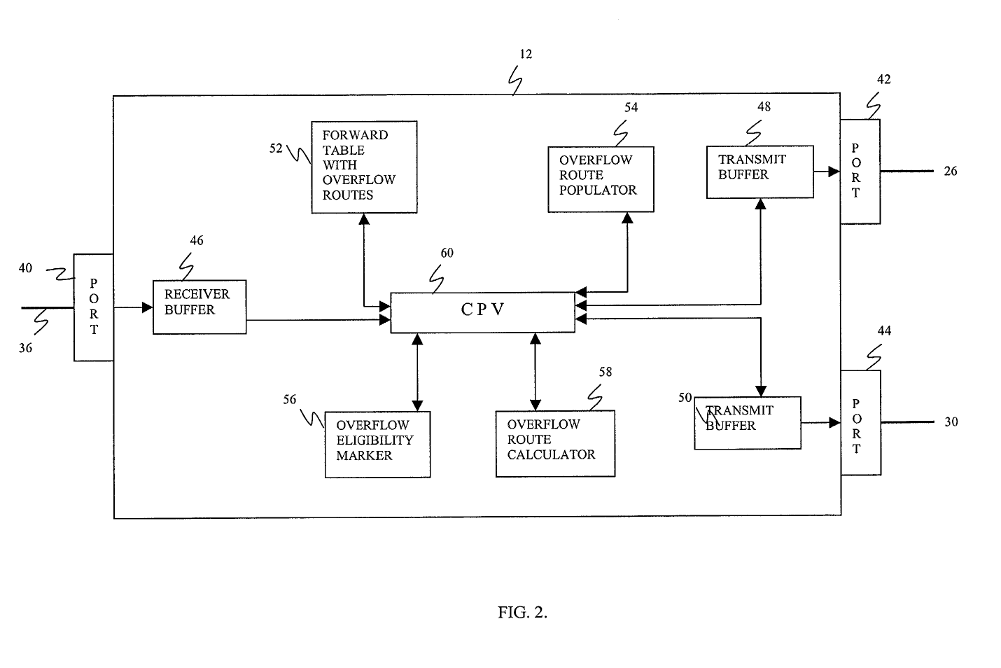

An arrangement of one of the routers 12 is shown in FIG. 2. This router 12 is shown with three links 26, 30, and 36. Router 12 includes a receive buffer 46 corresponding to port 40 and link 36, a transmit buffer 48 corresponding to port 42 and link 26, as well as a transmit buffer 50 corresponding to port 44 and link 30. Links are typically bi-directional and each link usually has a transmit as well as a receive buffer. The transmit buffer of link 36 and the receive buffers of links 26, 30 are not shown in FIG. 2. IP packets received by the router 12 in the receiver buffer 46 may be forwarded or routed to the transmit buffer 48, 50 of either one of the links 26, 30. The router 12 may include a plurality of receive and transmit buffers to support multiple classes of packets of data on each link.

The router 12 also includes a forwarding table 52 (or routing table) that may be created using any of the standard routing protocols, such as the OSPF routing protocol. Usually, one table is calculated centrally in the router 12 and then an identical copy may be stored in each port card (not shown) for ports 40, 42, 44. The copies may be customized for each port. The forwarding table contains entries that list the source port ID, source IP address, destination IP address, and destination port ID. In addition, the forwarding table 52 typically has another field in each entry that lists the next hop or outgoing link chosen by the routing protocol. According to the present invention, the forwarding table 52 may store outgoing links corresponding to at least two paths or routes for selected table entries. One of the paths may be designated as the primary path in the forwarding table. Other paths may also be labeled according to priority as overflow paths.

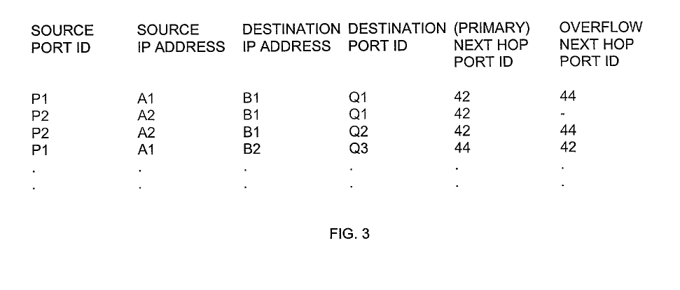

An example of a forwarding table is shown in FIG. 3. FIG. 3 shows a possible entry having source port ID of P1, source IP address A1, destination IP address B1, and destination port ID Q1, among other possible information. The destination IP address, and possibly other fields, on an IP packet may be matched with a forwarding table entry(ies) according to standard practice. The next hop port ID in the matching entry informs the router 12 of the output port to which the IP packet should be forwarded. Thus, an IP packet that matches the first entry shown in FIG. 3 will be routed to the transmit buffer 48 in port 42. According to the present invention, the next hop port ID may be identified as the primary port ID. The forwarding table 52 may include at least one more column in which the overflow next hop port ID is stored for selected destination IP addresses, as discussed below. The next hop port IDs respectively corresponding to the overflow paths may be stored in different ways. For example, each overflow path may have a separate entry for itself. Consequently, several entries in the table may have identical values in the first four columns shown in FIG. 3, but will differ in the fifth column. An overflow eligibility marker 56 may be provided in the router 12 to determine combinations of source port IDs, IP addresses, and destination IP addresses that are eligible for overflow routing. This may be done via negotiations with customers, network policy, Quality of Service (QoS) parameters, etc. More particularly, not all packets of information are eligible for overflow routing. For example, changing the path of an IP packet flow midstream may result in the packets arriving at the destination out of sequence, requiring re-sequencing upon receipt, which may be undesirable. For example, re-sequencing of voice packets transmitted on an IP network is usually not desirable. Therefore, voice IP packets may not be eligible for overflow routing. One area where overflow techniques may be applied is in the area of IP packets destined to other Internet Service Providers (ISPs). As another example, a contract with a customer may specify how much traffic (i.e., number of packet bytes over time) the customer may send on a regular basis. An enhanced contract may accept additional traffic at perhaps a cheaper rate so long as it is overflow eligible, for example.

According to an aspect of the present invention, the router 12 may have a list of destination IP addresses, from among all possible addresses, identified by a network administrator, for example, as being eligible for overflow routing. When the routing protocol constructs the forwarding table, only the next hop of one possible path will be stored for those addresses for which overflow routing is not available. For those addresses that are eligible for overflow routing, the routing protocol will put in the next hops of more than one possible path based upon the destination IP address. The routing is usually determined by the destination IP address. The priority of the packet may be indicated in the Type of Service (TOS) field in the IP header. The process for determining priority of IP packets is standard in IP packet processing and is well known to those of ordinary skill in the art. The overflow paths may be prioritized based on the possible priorities of IP packets.

An overflow route calculator 58 in router 12 determines at least one overflow path, in addition to the primary path, for each destination IP address eligible for overflow as indicated by the overflow eligibility marker 56. Any standard method for determining an additional path(s) may be used. The K-shortest path algorithm and the K-diverse-shortest path algorithm are examples of methods that are well known in the art to generate multiple paths. For example, the additional path(s) may be based on several criteria. One criterion may be that the additional path(s) start at a different port on the router. It may be desirable to have the additional paths(s) have as few links and/or routers as possible in common with the first path to the destination in order to avoid the possibility of congestion on all possible paths.

An overflow route populator 54 may be provided in the router 12 to populate the forwarding table 52 with all of the overflow paths provided by the overflow route calculator 58. A forwarding table populated with overflow routes is shown in FIG. 3. The first entry in the table has two associated paths, the primary path with a next hop port ID of 42 and the overflow path with a next hop port ID of 44. The second entry does not have an overflow path and the destination IP address corresponding to this entry may not have been eligible for overflow. It is not necessary that the overflow paths be listed in the same forwarding table entry following the primary path. An alternate means may be to create several entries, which are identical in the first four fields but have different next hop port IDs. The first of these entries will be designated as the primary path, and subsequent identical matching entries as overflow paths. Any other suitable means may be used to store the overflow paths in forwarding tables.

The elements of the router 12 may be combined in any appropriate manner to perform the processing set forth above.

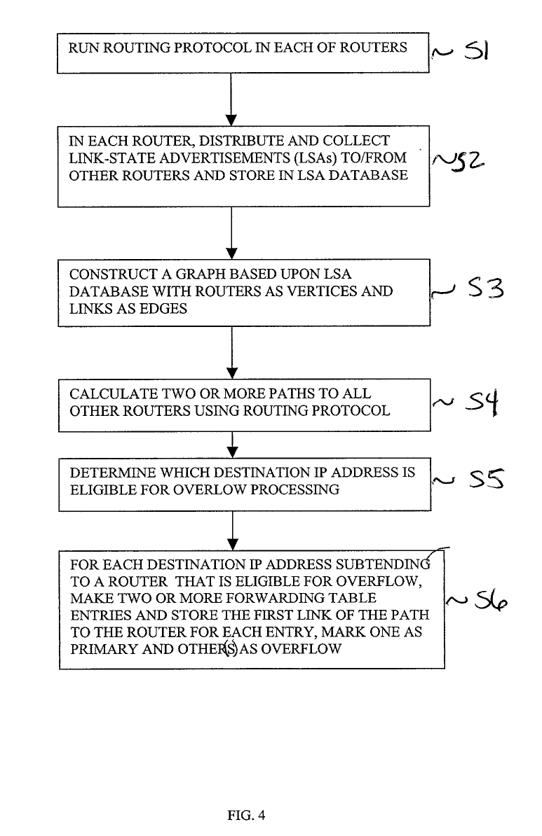

An example of the processing performed to generate the forwarding table 52 is shown in FIG. 4. In step S1, the routing protocol is run in each of the routers 12, 14, 16, and 18. In step S2, each router distributes/collects link-state advertisements (LSAs) to/from other routers in the network and the LSA information may be stored in a database of each router. A graph may be constructed in each router using the LSA information in step S3. In step S4, in each router, the routing protocol calculates at least two paths to all other routers for each destination IP address. Those destination IP addresses that are eligible for overflow processing are detected in step S5. In step S6, in each router, for each destination IP address that is eligible for overflow routing, at least two forwarding table entries are stored together with the first link for each of the possible paths is stored, one being marked primary and the other(s) being marked overflow. The order of steps S4 and S5 may be reversed.

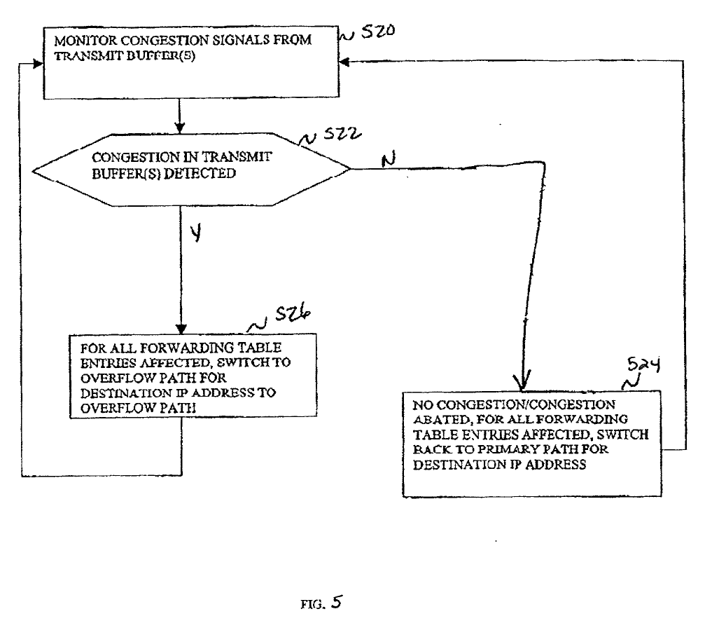

Overflow processing according to an aspect of the present invention is shown in FIG. 5. In step S20, each router monitors for receipt of congestion signals from its transmit buffer(s). The present invention may be used with RED, WRED, BLUE or any other method of detecting congestion. In step S22, it is determined whether the router detects congestion in the transmit buffer(s). If the answer in step S22 is Yes, then step S26 is performed. In step S26, for all forwarding table entries affected, the router switches the output path of the corresponding output port from the primary path to an overflow path. If the answer in step S22 is No, then processing continues to step S24. In step S24, it is determined that there is no congestion or that any previous congestion has abated, and for all forwarding tables previously affected by congestion, the router switches the output path of the corresponding output port back to the primary path.

According to the present invention, the router 12 may only take an overflow path if that path itself is not congested. In an embodiment where more than one overflow path is provided for those addresses for which overflow processing is available, the router will select an overflow path that is not congested, or one that is less congested than the other(s). However, if the situation arises where all of the possible output paths are congested, or where the only overflow path is congested, the router may have to resort to dropping IP packets.

According to another embodiment of the invention, various levels or grades of congestion may be detected at an output port, and overflow processing may be controlled based upon the level of congestion. More particularly, the different levels of congestion may respectively correspond to different levels of fullness of the transmit buffer for an output port. For example, various thresholds may be set in the transmit buffer and as these thresholds are exceeded, congestion moved from one grade to another.

More particularly, a processor in the transmit buffer for the output port may detect a particular level of congestion and output congestion information that may include information identifying the particular level of congestion. The response of the input port may be dictated by the level of congestion detected at the output port. For example, for each level of congestion, the input port may provide for an associated percentage of data to be overflowed, where the percentage of data to be overflowed increases as the level of congestion increases.

According to another example, different congestion levels may lead to a different number or percentage of the eligible IP addresses may be overflowed. This determination may be based simply on counting the number of addresses that can be overflowed or it can be based on some measurement of data that came in on those addresses in the last time interval, for example. More particularly, there may be eligible IP addresses that can be overflowed that are headed for a particular port, and based on the level of congestion, perhaps 10% of these eligible IP addresses will be overflowed. The method for accomplishing this overflow may be specific or random.

It will be appreciated by those of ordinary skill in the art that many schemes may be provided for controlling overflow processing based upon detected levels of congestion. For example, a scheme may take measurements on previous time intervals and determine that on a particular IP address, in the last time interval, i.e., 10 minutes, a particular number of packets or so many bytes of data were received, and so on for the remainder of eligible IP addresses. The measurement information may then be used to determine the amount of overflow on each of the eligible IP addresses.

The different levels of congestion may be determined in any suitable manner. For example, threshold levels and associated overflow levels may be set by the manufacturer of the router and adjusted by an administrator, or set by the administrator. Any number of congestion levels and corresponding overflow levels may be used.

The present invention may also be implemented with other protocols such as the MPLS protocol. In the MPLS protocol, each IP packet is encapsulated in a new header or label and is provided with an MPLS label ID. A sequence of label assignments, one label for each link in the path, may be used to establish an end-to-end MPLS path between routers in the network for each destination IP address. Again, as in the case of IP networks, the path may correspond to an aggregated set of destination IP addresses, indicated by an IP address and prefix or IP address and mask. When a packet is switched from an incoming port to an outgoing port inside an MPLS network, the incoming label is removed and the packet is encapsulated in a new (outgoing) label.

The situation is slightly different in the edges of an MPLS network. An IP packet entering an MPLS network is assigned an MPLS label by the ingress router based on the destination IP address. Conversely, an IP packet leaving an MPLS network is stripped of its MPLS label by the egress router. The forwarding tables inside an MPLS network contain this association of incoming labels on a port and the outgoing port and the label assigned to that path. The forwarding tables in ingress routers in an MPLS network contain the association between incoming destination IP addresses on a port and the outgoing port and the MPLS label assigned to that path. The forwarding tables in egress routers in an MPLS network contain the association between incoming MPLS labels on a port and the outgoing port assigned to that path. The arrangement of networks using MPLS is well known in the art.

According to the present invention, at least two end-to-end paths may be determined and stored in a forwarding table for each destination IP address. Different (sequence of) labels may be assigned to the end-to-end paths assigned to a particular destination IP address. According to the present invention, a particular end-to-end path for a destination IP address may be selected based upon congestion information in the same manner as discussed above. In other words, a particular path, or the primary end-to-end path may be selected for a particular destination IP address, unless congestion is detected on the outgoing link or the first hop of this path in the network. When congestion is detected, its status is conveyed to the incoming links in the router. Each incoming link may now select an overflow end-to-end path for the particular destination IP address. The overflow path will indicate a different outgoing link and a different label than the primary path. Once again, any method may be used to detect congestion in the network.

As demonstrated by the foregoing, the present invention provides a solution to the problem of dropping IP packets due to network congestion by providing a method and apparatus that communicates congestion status among the ports inside a router and provides overflow paths for particular destination IP addresses, and outputs IP packets on one of the overflow paths when congestion is detected on the primary path for a particular destination IP address. According to the present invention, for those address for which overflow processing is available, multiple overflow paths may be selected and stored in the forwarding table.

While particular embodiments of the invention have been shown and described, it is recognized that various modifications thereof will occur to those skilled in the art without departing from the spirit and scope of the invention. The described embodiments are to be considered in all respects only as illustrative and not restrictive. Therefore, the scope of the herein-described invention shall be limited solely by the claims appended hereto.

What is claimed is:

1. A method of managing data flow in a router in a network, comprising:
monitoring congestion status on each output port of the router; and
switching, upon detection of congestion on one of the output ports, output of data from a primary output path of the one of the output ports corresponding to a destination address of the data to be output, to an overflow path for the destination address.

2. The method according to claim 1, further comprising:
detecting when the congestion has abated; and
switching the output of data from the overflow path back to the primary path for the destination address.

3. The method according to claim 1, further comprising:
storing a forwarding table in the router, the forwarding table having entries respectively corresponding to destination addresses in the network and identifying at least two output paths from the router for at least some of the destination addresses to enable overflow routing, one of the at least two output paths being identified as a primary path and other output paths being identified as overflow paths.

4. The method according to claim 3, further comprising:
determining, upon detection of congestion on the one of the output ports, which one of the at least two overflow paths from which to output the data based upon an amount of data currently assigned to be output from each of the at least two overflow paths.

5. The method according to claim 4, wherein the determining step comprises:
Determining the amount of data currently assigned to be output from each of the at least two output paths;
determining which one of the at least two overflow paths has the least amount of data to be output; and
assigning the data to be output from the at least one of the overflow paths having the least amount of data to be output.

6. A method of managing data flow in a router in a network, wherein the router includes a forwarding table having entries respectively corresponding to destination addresses in the network and identifying at least two output paths from the router for at least some of the destination addresses to enable overflow routing, one of the at least two output paths being identified as a primary path and other output paths being identified as an overflow paths, the method comprising:
monitoring receipt of congestion signals from at least two transmit buffers respectively associated with at least two output ports of the router;
detecting a congestion signal from at least one of the at least two transmit buffers in the router; and
switching, for all of the destination addresses in the forwarding table affected by the detection of congestion and eligible for overflow routing, from the primary path to one of the overflow paths for transmitting the data.

7. The method according to claim 6, further comprising:
determining when the congestion has abated based upon status of the congestion signals; and
switching, for all of the destination addresses in the forwarding table switched to overflow routing, from the overflow path back to the primary path when the congestion has abated.

8. A method of managing data flow in a router in a network, comprising:
storing a forwarding table in the router, the forwarding table having entries respectively corresponding to destination addresses in the network and identifying at least two output paths from the router for at least some of the destination address to enable overflow routing, one of the at least two output paths being identified as a primary path and any other output path being identified as an overflow path;
monitoring receipt of congestion signals from at least two transmit buffers respectively associated with at least two output ports of the router;
detecting a congestion signal from at least one of the at least two transmit buffers in the router; and
switching, for all of the destination addresses in the forwarding table affected by the detection of congestion and eligible for overflow routing, from the primary path to the overflow path for transmitting the data.

9. The method according to claim 8, further comprising:
determining when the congestion has abated based upon status of the congestion signals; and
switching, for all of the destination addresses in the forwarding table switched to overflow routing, from the overflow path back to the primary path when the congestion has abated.

10. A method of managing data flow in a router of a network, comprising:
running a routing protocol in the router;
determining at least two output paths for each of a plurality of destination addresses based upon the routing protocol;
determining which of the destination addresses are eligible for overflow routing; and
storing, for each of the destination addresses eligible for overflow routing, the at least two output paths.

11. The method according to claim 10, wherein the storing step comprises:
storing, for each of the destination addresses other than the destination addresses eligible for overflow routing, one output path.

12. The method according to claim 10, further comprising:
monitoring congestion status on each output port of the router; and
switching, upon detection of congestion on one of the output ports, output of data from a primary output path of the one of the output ports corresponding to a destination address of the data to be output to an overflow path for the destination address.

13. The method according to claim 12, further comprising:
detecting when the congestion has abated; and
switching the output of data from the overflow path back to the primary path for the destination address.

14. A method of managing data flow in a router in a network, comprising:
monitoring congestion status on each output port of the router, wherein the congestion status is one of a plurality of levels of congestion;
detecting a level of congestion from the plurality of levels of congestion on at least one output port of the router;
determining an amount of data to be overflowed based upon the level of congestion; and
switching, upon detection of the one of the plurality of levels of congestion on the at least one output port, the amount of data to be overflowed from a primary output path of the at least one output port corresponding to a destination address of the data to be output, to an overflow path for the destination address.

15. The method according to claim 14, further comprising:
detecting when the level of congestion has abated; and
switching the output of the at least one output port from the overflow path back to the primary path for the destination address.

16. The method according to claim 14, further comprising: storing a forwarding table in the router, the forwarding table having entries respectively corresponding to destination addresses in the network and identifying at least two output paths from the router for at least some of the destination addresses to enable overflow routing; and
storing, for each of the at least some of the destination addresses, a plurality of overflow data amounts respectively corresponding to the plurality of levels of congestion.
